(19) United States
(12) Patent Application Publication
(10) Pub. No.: US 2011/0187152 A1
(43) Pub. Date: Aug. 4, 2011

(54) SAFETY PROTECTION CANOPY FOR MOTOR/MAN-POWERED VEHICLE

(76) Inventor: CHENG-CHI LIN, TAIPEI HSIEN (TW)

(21) Appl. No.: 12/721,819

(22) Filed: Mar. 11, 2010

(30) Foreign Application Priority Data
Feb. 4, 2010 (TW) 099202346

(51) Int. Cl. B62D 33/06

(52) U.S. Cl. 296/181.1

(57) ABSTRACT

A safety protection canopy for motor/man-powered vehicle includes: a front face section mounted in front of a seat section of the motor/man-powered vehicle, the front face section having a front cushioning member; a rear face section mounted behind the seat section of the motor/man-powered vehicle, the rear face section having a rear cushioning member; and a top face section mounted above the seat section of the motor/man-powered vehicle. The top face section has a front side connected with the front face section and a rear side connected with the rear face section. The top face section further has a top cushioning member.

### BACKGROUND OF THE INVENTION

1. Field of the Invention

The present invention relates to a safety protection canopy for motor/man-powered vehicle. The safety protection canopy includes cushioning members are made of such as inflatable envelopes for enclosing a rider and a passenger therein. The safety protection canopy can buffer the impact of alien articles and the ground on the rider and the passenger so as to ensure safety of the rider and the passenger. Also, the safety protection canopy can achieve windproof, rainproof and sunproof effect.

2. Description of the Prior Art

In the existent transportation tools, man-powered vehicles such as motorcycles and bicycles pertain to highly dangerous transportation tools. When riding a motorcycle or a bicycle, a rider is exposed to the ambient environment without any protection. In case of an accident or a crash, the rider's body will directly scrape or hit alien articles and the ground. This often causes serious wound or death.

Moreover, a motorcycle or any other man-powered vehicle lacks any windproof, rainproof or sunproof design. Therefore, when riding a motorcycles or a bicycle, a rider will suffer from cold wind, rain and sun scorch.

### SUMMARY OF THE INVENTION

It is therefore a primary object of the present invention to provide a safety protection canopy for motor/man-powered vehicle. The safety protection canopy includes: a front face section mounted in front of a seat section of the motor/man-powered vehicle, the front face section having a front cushioning member; a rear face section mounted behind the seat section of the motor/man-powered vehicle, the rear face section having a rear cushioning member; and a top face section mounted above the seat section of the motor/man-powered vehicle. The top face section has a front side connected with the front face section and a rear side connected with the rear face section. The top face section further has a top cushioning member.

The above safety protection canopy further includes side doors pivotally connected with the front face section for blocking side doorways between the front face section and the rear face section.

The safety protection canopy further includes: a front protective shell attached to outer face of the front cushioning member; a rear protective shell attached to outer face of the rear cushioning member; a top protective shell attached to outer face of the top cushioning member; and side door protective shells attached to outer faces of the side door cushioning members. The safety protection canopy further includes: a front protective frame mounted between the front protective shell and the front cushioning member and fixedly connected with/integrally extending from a head section of the motor/man-powered vehicle; a rear protective frame mounted between the rear protective shell and the rear cushioning member and fixedly connected with/integrally extending from a tail section of the motor/man-powered vehicle; a top protective frame mounted between the top protective shell and the top cushioning member, a front edge of the top protective frame being fixedly connected with/integrally extending from the front protective frame, while a rear edge of the top protective frame being fixedly connected with/integrally extending from the rear protective frame; and side door protective frames mounted between the side door protective shells and the side door cushioning members.

The safety protection canopy further includes window sheets, which are pivotally connected with upper edges of the side door protective shells. The window sheets can be pivoted up or down to seal or unseal the windows defined between the front protective shell, the rear protective shell, the top protective shell and the side door protective shells.

In the above safety protection canopy, the front protective shell, the rear protective shell and the top protective shell are integrally formed. The front cushioning member, the rear cushioning member, the top cushioning member and the side door cushioning members are made of cushioning materials selected from a group consisting of inflatable envelopes, foam rubber and polylon.

The safety protection canopy further includes a seat section safety belt. The seat section safety belt includes: a waist belt having two segments, the segments being buckled to each other by means of a buckle ring to fasten a rider's waist with the waist belt: and two sets of waist belts respectively connected to the two segments of the waist belt, rear ends of the waist belts being fixed to different portions of the seat section so as to three-point tightly fasten the rider to the seat section of the motor/man-powered vehicle.

The present invention can be best understood through the following description and accompanying drawings, wherein:

### BRIEF DESCRIPTION OF THE DRAWINGS

FIG. 1 is a perspective exploded view of a first embodiment of the present invention;

FIG. 2 is a perspective view showing that the first embodiment of the present invention is mounted on a motor vehicle;

FIG. 3 is a perspective exploded view of a second embodiment of the present invention;

FIG. 4 is a perspective exploded view of a third embodiment of the present invention;

FIG. 5 is a perspective assembled view of the third embodiment of the present invention;

FIG. 6 is a sectional view taken along line 6-6 of FIG. 5;

FIG. 7 is a side view showing that a fourth embodiment of the present invention is mounted on a man-powered vehicle;

FIG. 8 is a perspective exploded view of the door lock of the present invention; and

FIG. 9 is a view showing the use of the door lock of the present invention.

### DETAILED DESCRIPTION OF THE PREFERRED EMBODIMENTS

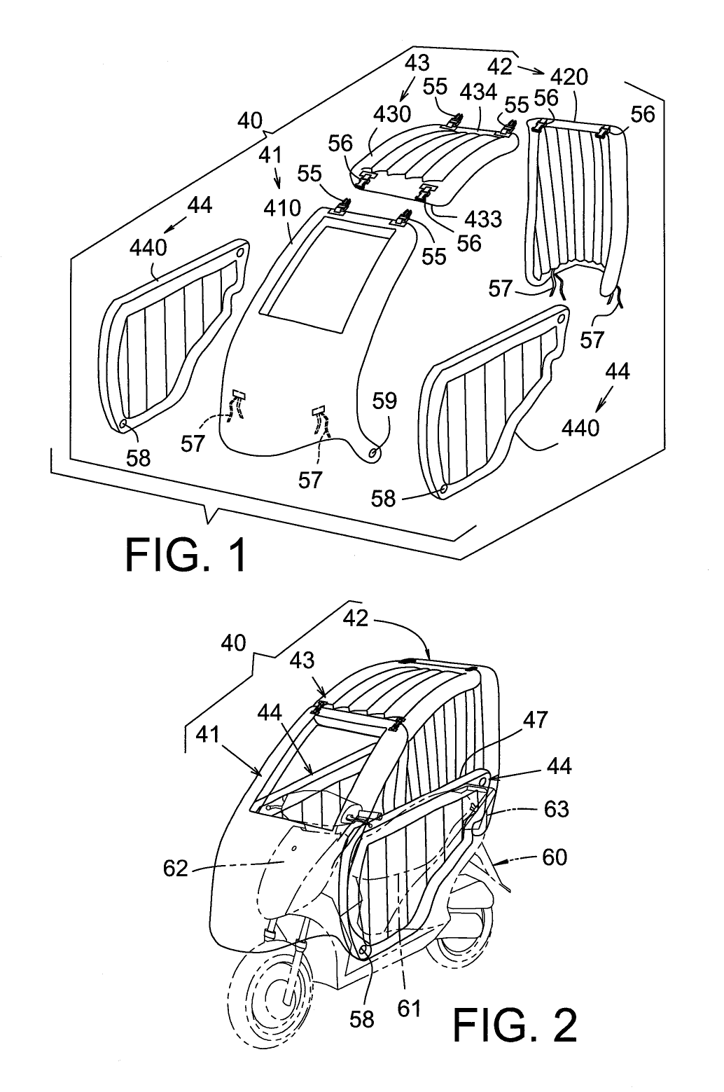

Please refer to FIGS. 1 and 2. The safety protection canopy 40 for motor/man-powered vehicle of the present invention includes a front face section 41, a rear face section 42 and a top face section 43. The front face section 41 is mounted in front of a seat section 61 of the motor/man-powered vehicle 60 and has a front cushioning member 410. The rear face section 42 is mounted behind the seat section 61 of the motor/man-powered vehicle 60 and has a rear cushioning member 420. The top face section 41 is mounted above the seat section 61 of the motor/man-powered vehicle 60. The top face section 43 has a front side 433 connected with the front face section 41 and a rear side connected with the rear face section 42. The top face section 43 further has a top cushioning member 430.

The front face section 41, the top face section 43 and the rear face section 42 are sequentially secured to and connected with each other by means of first fastening means 55 and second fastening means 56, which can be engaged with each other. Preferably, the front face section 41, the top face section 43 and the rear face section 42 are integrally formed as one-piece protection structure to provide better protection for a rider and a passenger.

The front face section 41 is equipped with tying means 57 for tying the front face section 41 on a head section 62 of the seat section 61 of the motor/man-powered vehicle 60. The rear face section 42 is also equipped with tying means 57 for tying the rear face section 42 on a tail section 63 of the seat section 61 of the motor/man-powered vehicle 60.

Referring to FIGS. 1 and 2, the present invention further includes two side doors 44 pivotally connected with the front face section 41 for blocking side doorways 47 between the front face section 41 and the rear face section 42. Each side door 44 has a side door cushioning member 440.

The side door 44 and the front face section 41 are respectively equipped with pivot sections 58, 59. The pivot sections 58, 59 are pivotally connected with each other to pivotally connect the side door 44 to one side of the front face section 41.

Referring to FIGS. 1 and 2, in a preferred embodiment, the front face section 41, the rear face section 42, the top face section 43 and the side doors 44 are respectively provided with the cushioning members to form the safety protection canopy 40 for the motor/man-powered vehicle.

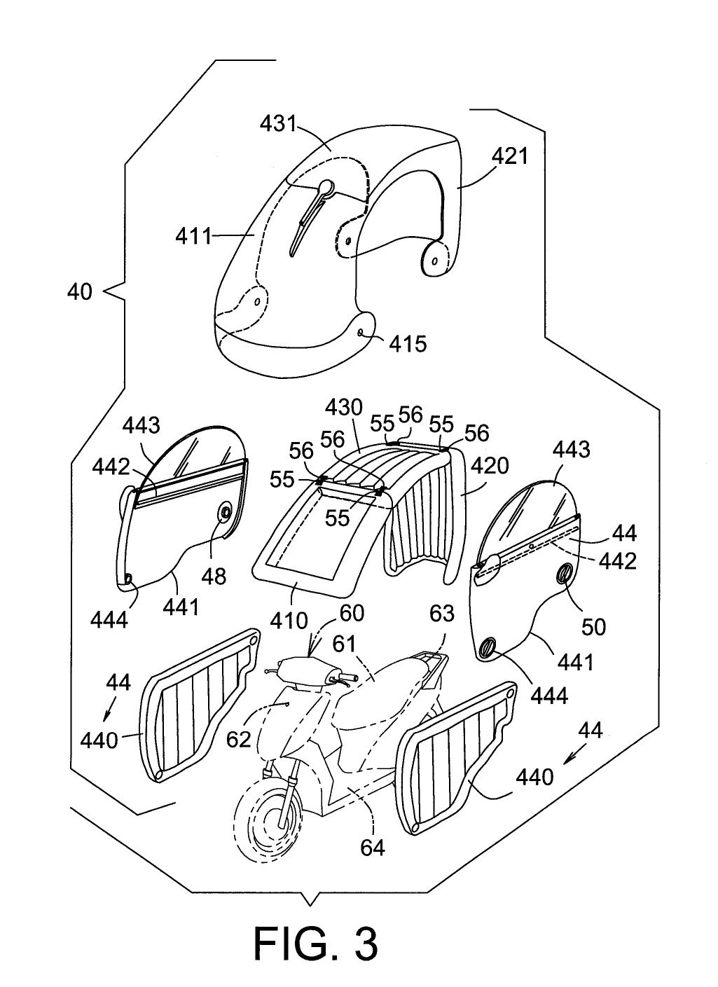

Referring to FIG. 3, according to another preferred embodiment, the safety protection canopy 40 for the motor/man-powered vehicle of the present invention further includes: a front protective shell 411 attached to outer face of the front cushioning member 410; a rear protective shell 421 attached to outer face of the rear cushioning member 420; a top protective shell 431 attached to outer face of the top cushioning member 430; and side door protective shells 441 attached to outer faces of the side door cushioning members 440.

Referring to FIG. 3, the front face section 41, the rear face section 42, the top face section 43 and the side doors 44 are respectively provided with the protective shells and the cushioning members to form the safety protection canopy 40 for the motor/man-powered vehicle.

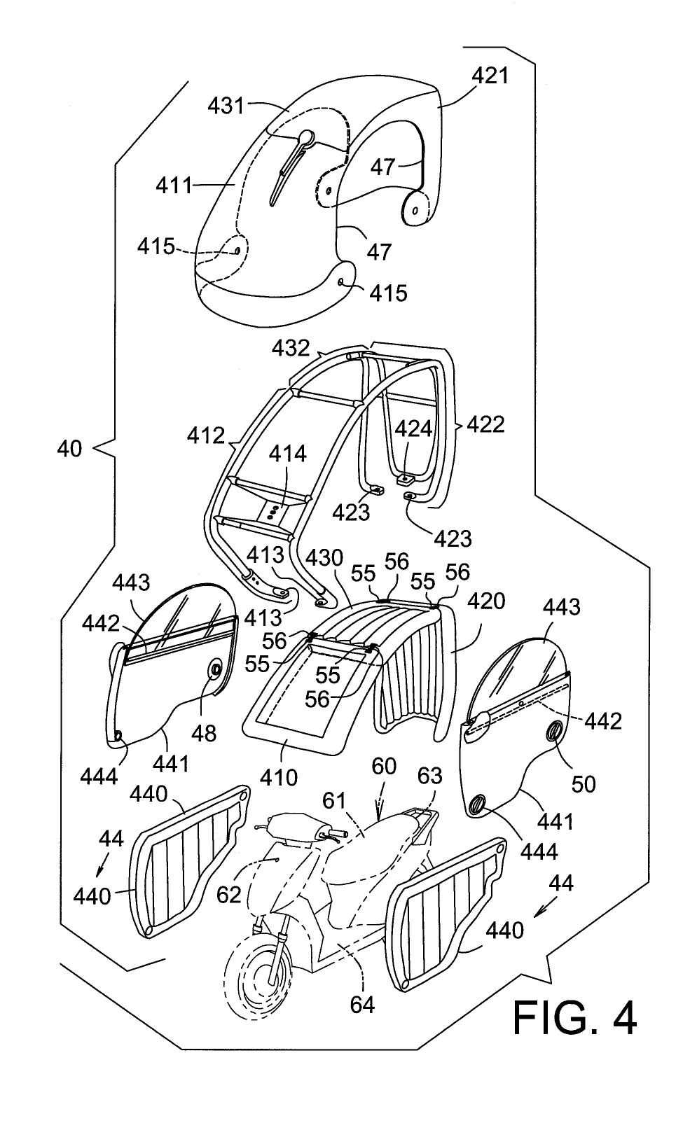

Referring to FIGS. 4, 5 and 6, according to still another preferred embodiment, the safety protection canopy 40 for the motor/man-powered vehicle of the present invention further includes: a front protective frame 412 mounted between the front protective shell 411 and the front cushioning member 410 and fixedly connected with the head section 62 of the motor/man-powered vehicle; a rear protective frame 422 mounted between the rear protective shell 421 and the rear cushioning member 420 and fixedly connected with the tail section 63 of the motor/man-powered vehicle; a top protective frame 432 mounted between the top protective shell 431 and the top cushioning member 430, a front edge of the top protective frame 432 being fixedly connected with the front protective frame 412, while a rear edge of the top protective frame 432 being fixedly connected with the rear protective frame 422; and side door protective frames 442 mounted between the side door protective shells 441 and the side door cushioning members 440.

Referring to FIGS. 4, 5 and 6, the front face section 41, the rear face section 42, the top face section 43 and the side doors 44 are respectively provided with the protective shells, the cushioning members and the protective frames to form the safety protection canopy 40 for the motor/man-powered vehicle.

Referring to FIGS. 4, 5 and 6, in the safety protection canopy 40 for the motor/man-powered vehicle of the present invention, the front protective frame 412 has: two first securing sections 413, which are fixedly connected to a deck 64 of the motor/man-powered vehicle 60 by means of bolts 416; and a second securing section 414, which is fixedly connected to a front fork (not shown) of the head section 62 of the motor/man-powered vehicle 60 by means of a bolt 417. The rear protective frame 422 has: two third securing sections 423, which are fixedly connected to the tail section 63 of the motor/man-powered vehicle 60 by means of bolts 418; and a fourth securing section 424, which is fixedly connected to the tail section 63 of the motor/man-powered vehicle 60 by means of a bolt 419.

Referring to FIGS. 4, 5 and 6, according to still another preferred embodiment, the safety protection canopy 40 for the motor/man-powered vehicle of the present invention further includes: a front protective frame 412 mounted between the front protective shell 411 and the front cushioning member 410 and integrally extending from the head section 62 of the motor/man-powered vehicle 60; a rear protective frame 422 mounted between the rear protective shell 421 and the rear cushioning member 420 and integrally extending from the tail section 63 of the motor/man-powered vehicle 60; and a top protective frame 432 mounted between the top protective shell 431 and the top cushioning member 430 and integrally extending between the front protective frame 412 and the rear protective frame 422.

Referring to FIGS. 4, 5 and 6, preferably, the front protective shell 411, the rear protective shell 421 and the top protective shell 431 are integrally formed as a concrete protective structure to provide best protection effect for a rider and a passenger.

Referring to FIGS. 4, 5 and 6, the safety protection canopy 40 for the motor/man-powered vehicle of the present invention further includes two window sheets 433 pivotally connected with upper edges of the side door protective shells 441. The window sheets 443 can be pivoted down and hidden behind the side door protective shells 441 or pivoted upward to upper sides of the side door protective shells 441 so as to seal two windows 45 defined between the front protective shell 411, the rear protective shell 421, the top protective shell 431 and the side door protective shells 441.

Referring to FIGS. 4, 5 and 6, the cushioning members, the protective shells and the protective frames are assembled to form the safety protection canopy 40 for the motor/man-powered vehicle of the present invention. Two first pivot sections 415 are respectively disposed on two sides of the front protective shell 411. The side door protective shells 441 are respectively provided with second pivot sections 444. The second pivot sections 444 are pivotally mounted on the first pivot sections 415, whereby the side door protective shells 441 can be pivoted relative to the front protective shell 411 to unblock the side doorways 47 (with reference to FIG. 4 and FIG. 6, which shows that the side doorways 47 are unblocked). Alternatively, the side door protective shells 441 can be pivoted to block the side doorways 47. After the side doorways 47 are blocked, the side door protective shells 441 can be locked by means of door locks 50.

Referring to FIGS. 1, 3, 4 and 6, in the safety protection canopy 40 for the motor/man-powered vehicle of the present invention, the front cushioning member 410, the rear cushioning member 420, the top cushioning member 430 and the side door cushioning members 440 are made of cushioning materials selected from a group consisting of inflatable envelopes, foam rubber, polylon, etc.

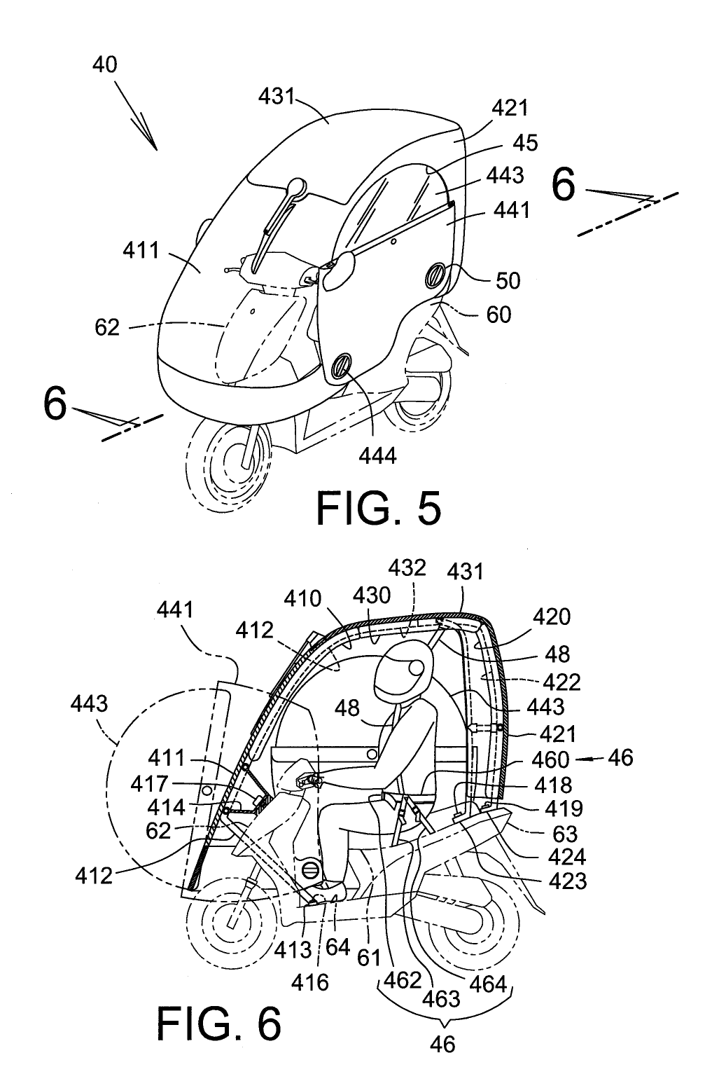

Referring to FIGS. 5 and 6, the safety protection canopy 40 for the motor/man-powered vehicle of the present invention further includes a seat section safety belt 46. The seat section safety belt 46 includes a waist belt 460 having two segments. The segments are buckled to each other by means of a buckle ring 462 to fasten a rider's waist with the waist belt 460. The seat section safety belt 46 further includes two sets of waist belts 463, 464 respectively connected to the two segments of the waist belt 460. Rear ends of the waist belts 463, 464 are fixed to different portions of the seat section 61 so as to three-point tightly fasten the rider to the seat section 61 of the motor/man-powered vehicle 60.

Referring to FIGS. 5 and 6, in the safety protection canopy 40 for the motor/man-powered vehicle of the present invention, the windows 45 are formed above the left and right side door protective shells 441. The window sheets 443 are pivotally mounted on the side door protective shells 441 to seal the windows 45 so as to achieve windproof and rainproof effect without obstructing the sight of the rider. The window sheets 443 can be turned down to unseal the windows 45 for ventilation.

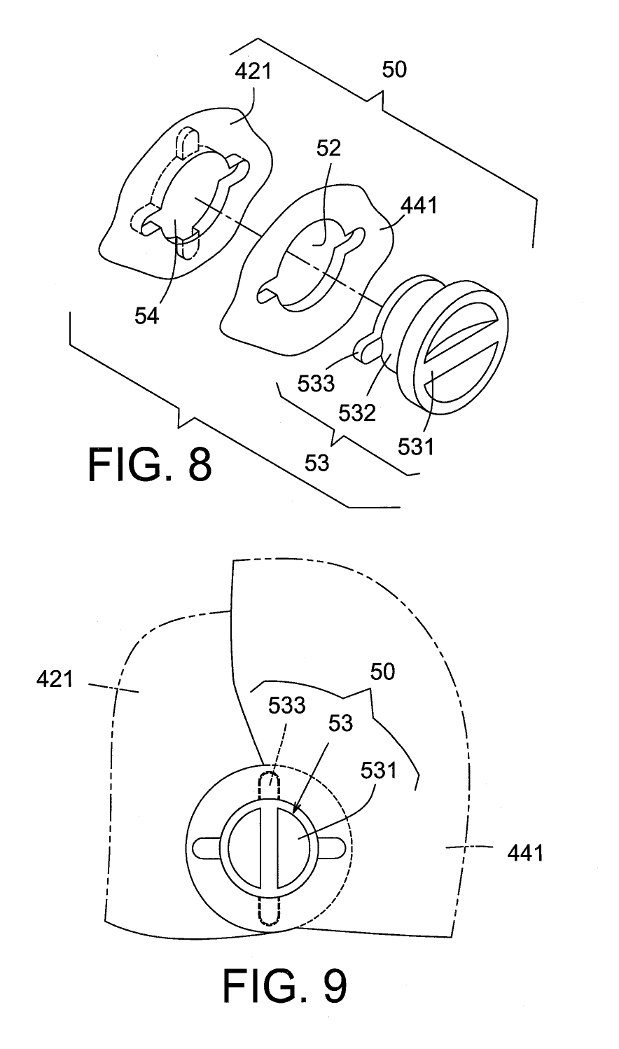

Please refer to FIGS. 4 and 5 as well as FIGS. 8 and 9, which show the detailed structure of the door lock 50. The door lock 50 includes a rotary switch 53 having a tray body 531 and a shaft section 532 disposed on one side of the tray body 531. A protruding key 533 is disposed on a circumference of the shaft section 532. The side door protective shell 441 is formed with a pivot hole 52 and the rear protective shell 421 is formed with a pivot hole 54 in alignment with the pivot hole 52. The shaft section 532 can be axially passed through the pivot hole 52 of the side door protective shell 441 and the pivot hole 54 of the rear protective shell 421. Afterwards, the rotary switch 53 is rotated by a certain angle to latch the protruding key 533 with inner side of the rear protective shell 421. The rotary switch 53 can be rotated to unlatch the protruding key 533 from the rear protective shell 421. At this time, the side door protective shell 441 can be opened for the rider or the passenger to get on or get off.

Referring to FIG. 6, the present invention further includes a safety belt 48 having an upper end and a lower end. The upper end of the safety belt 48 is fixed to the top protective frame 432, while the lower end of the safety belt 48 can be secured to the waist belt 460. In case of an accident, the safety belt 48 serves to protect the rider from being thrown away from the vehicle body.

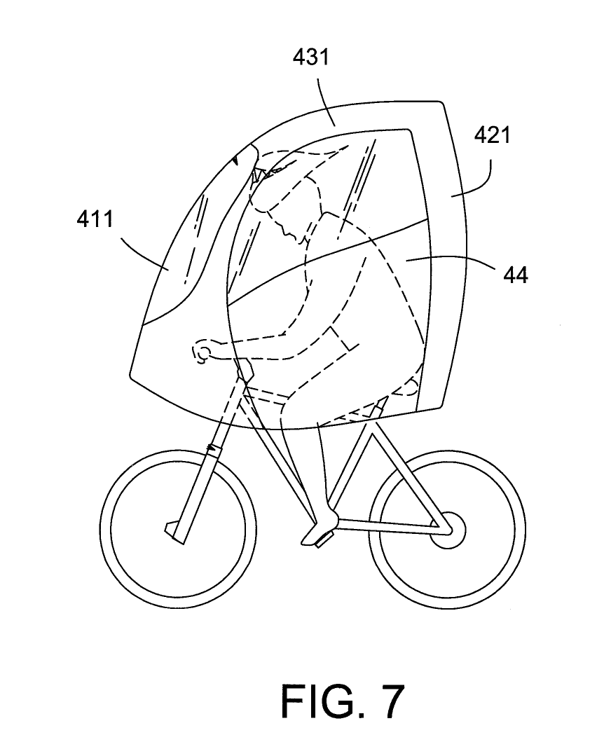

FIG. 7 shows the application of the embodiment of FIG. 3 to a man-powered vehicle (such as a bicycle).

According to the aforesaid, the safety protection canopy for the motor/man-powered vehicle of the present invention has the following advantages:

1. The safety protection canopy for the motor/man-powered vehicle of the present invention can be simply composed of the cushioning members or composed of the cushioning members and the protective shells or composed of the cushioning members, the protective shells and the protective frames. A rider and a passenger can be safely enclosed in the safety protection canopy. In case of an accident or a crash, the safety protection canopy can buffer the impact of alien articles and the ground on the rider and the passenger. Also, the safety protection canopy can protect the rider from being directly abraded by the ground or any alien article. Moreover, the safety protection canopy can prevent the rider from being thrown away from the vehicle body. Accordingly, the safety protection canopy can provide safety protection effect for the rider and the passenger and achieve windproof, sunproof and rainproof effect.

2. In the safety protection canopy for the motor/man-powered vehicle of the present invention, the cushioning members are made of inflatable envelopes. Therefore, the cushioning members have simple and lightweight structures. After inflated, the cushioning member can provide excellent protection effect. In addition, the cushioning members are easy to install, uninstall, fold and store.

3. In the safety protection canopy for the motor/man-powered vehicle of the present invention, the front side and the left and right sides of the rider are provided with transparent windows so that there is no blind spot and the sight of the rider will not be obstructed. The window of the front side can be equipped with a wiper to keep a good vision in case of rain.

The above embodiments are only used to illustrate the present invention, not intended to limit the scope thereof. Many modifications of the above embodiments can be made without departing from the spirit of the present invention.

What is claimed is:

1. A safety protection canopy for motor/man-powered vehicle, comprising:
a front face section mounted in front of a seat section of the motor/man-powered vehicle, the front face section having a front cushioning member;
a rear face section mounted behind the seat section of the motor/man-powered vehicle, the rear face section having a rear cushioning member;
a top face section mounted above the seat section of the motor/man-powered vehicle, the top face section having a front side connected with the front face section and a rear side connected with the rear face section, the top face section further having a top cushioning member;
a front protective shell attached to outer face of the front cushioning member;
a rear protective shell attached to outer face of the rear cushioning member; and
a top protective shell attached to outer face of the top cushioning member.

2. The safety protection canopy for the motor/man-powered vehicle as claimed in claim 1, further comprising side doors pivotally connected with the front face section for blocking side doorways between the front face section and the rear face section.

3. The safety protection canopy for the motor/man-powered vehicle as claimed in claim 2, wherein each side door has a side door cushioning member.

4. The safety protection canopy for the motor/man-powered vehicle as claimed in claim 3, further comprising side door protective shells attached to outer faces of the side door cushioning members.

5. The safety protection canopy for the motor/man-powered vehicle as claimed in claim 4, further comprising:
a front protective frame mounted between the front protective shell and the front cushioning member and fixedly connected with a head section of the motor/man-powered vehicle;
a rear protective frame mounted between the rear protective shell and the rear cushioning member and fixedly connected with a tail section of the motor/man-powered vehicle;
a top protective frame mounted between the top protective shell and the top cushioning member, a front edge of the top protective frame being fixedly connected with the front protective frame, while a rear edge of the top protective frame being fixedly connected with the rear protective frame; and
side door protective frames mounted between the side door protective shells and the side door cushioning members.

6. The safety protection canopy for the motor/man-powered vehicle as claimed in claim 5, wherein the front protective frame, the rear protective frame and the top protective frame are integrally connected with each other to form an integrated structure.

7. The safety protection canopy for the motor/man-powered vehicle as claimed in claim 6, wherein the front protective frame has:
two first securing sections, which are fixedly connected to a deck of the motor/man-powered vehicle; and
a second securing section, which is fixedly connected to a front fork of the head section of the motor/man-powered vehicle.

8. The safety protection canopy for the motor/man-powered vehicle as claimed in claim 7, wherein the rear protective frame has:
two third securing sections, which are fixedly connected to the tail section of the motor/man-powered vehicle; and
a fourth securing section, which is fixedly connected to the tail section of the motor/man-powered vehicle.

9. The safety protection canopy for the motor/man-powered vehicle as claimed in claim 4, further comprising:
a front protective frame mounted between the front protective shell and the front cushioning member and integrally extending from the head section of the motor/man-powered vehicle;
a rear protective frame mounted between the rear protective shell and the rear cushioning member and integrally extending from the tail section of the motor/man-powered vehicle; and
a top protective frame mounted between the top protective shell and the top cushioning member and integrally extending between the front protective frame and the rear protective frame.

10. The safety protection canopy for the motor/man-powered vehicle as claimed in claim 4, further comprising window sheets, which are pivotally connected with upper edges of the side door protective shells, whereby the window sheets can be pivoted down and hidden behind the side door protective shells or pivoted upward to upper sides of the side door protective shells so as to seal windows defined between the front protective shell, the rear protective shell, the top protective shell and the side door protective shells.

11. The safety protection canopy for the motor/man-powered vehicle as claimed in claim 10, wherein the front protective shell, the rear protective shell and the top protective shell are integrally formed.

12. The safety protection canopy for the motor/man-powered vehicle as claimed in claim 5, wherein the front cushioning member, the rear cushioning member, the top cushioning member and the side door cushioning members are made of cushioning materials selected from a group consisting of inflatable envelopes, foam rubber and polylon.

13. The safety protection canopy for the motor/man-powered vehicle as claimed in claim 5, further comprising a seat section safety belt, the seat section safety belt including:
a waist belt having two segments, the segments being buckled to each other by means of a buckle ring to fasten a rider's waist with the waist belt: and
two sets of waist belts respectively connected to the two segments of the waist belt, rear ends of the waist belts being fixed to different portions of the seat section so as to three-point tightly fasten the rider to the seat section of the motor/man-powered vehicle.
